(19) United States
(12) Patent Application Publication
(10) Pub. No.: US 2012/0032755 A1
(43) Pub. Date: Feb. 9, 2012

(54) DELAY LINE STRUCTURE

(75) Inventors: Guang-Hwa SHIUE, Chung Li (TW); Po-Wei CHIU, Chung Li (TW)

(73) Assignee: CHUNG YUAN CHRISTIAN UNIVERSITY, Chung Li (TW)

(21) Appl. No.: 13/181,613

(22) Filed: Jul. 13, 2011

(30) Foreign Application Priority Data
Aug. 4, 2010 (TW) 099125912

(51) Int. Cl. H01P 1/18

(52) U.S. Cl. 333/161

(57) ABSTRACT

A delay line structure includes a serpentine delay line, a first grounding guard trace and a second grounding guard trace. The serpentine delay line is disposed in a layout layer of a substrate in a manner of extending from an input end to an out put end in serpentine so as to form at least a first coupling area having a first opening toward a first direction and at least a second coupling area having a second opening toward a direction opposite to the first direction. The first grounding guard trace is disposed in the layout layer in a manner of extending from the first opening toward the first coupling area and an end of the first grounding guard trace close to the first opening is electrically connected to the grounding circuit through a first via. The second grounding guard trace is disposed in the layout layer in a manner of extending from the second opening toward the second coupling area and an end of the second grounding guard trace close to the second opening is electrically connected to the grounding circuit through a second via.

This application claims the benefits of the Taiwan Patent Application Serial NO. 099125912 filed on Aug. 4, 2010, the subject matter of which is incorporated herein by reference.

### BACKGROUND OF THE INVENTION

1. Field of the Invention

The present invention relates to a delay line structure, and more particularly to a serpentine delay line structure with grounding guard traces.

2. Description of the Prior Art

Signal synchronizing is always a concern when it comes to the high speed digital signal. Usually the requirement of synchronizing signals is met by increasing delay time with a delay line.

To save space, the delay line is usually bent. There are various delay lines, among which a serpentine delay line is very common. Referring to FIG. 1, FIG. 1 illustrates a delay line structure in prior art. A serpentine delay line 11 is bent repeatedly and arranged on a substrate 100.

However, bending the delay line forms several coupling line segments in the delay line itself, also generates crosstalk noise disturbance and further affects a signal waveform received, which leads to misinterpretation on a voltage level of a digital signal. As a result, in prior art, a guard trace with both ends connecting to the ground is utilized for decreasing the crosstalk noise. Referring to FIG. 2, FIG. 2 is a schematic view showing a guard trace with both ends connecting to the ground being applied to a serpentine delay line in prior art. The serpentine delay line 11 is bent repeatedly and arranged on the substrate 100, and therefore a coupling area H1 opening toward a first direction S1 and a coupling area H2 opening toward a direction opposite to the first direction S1 are formed. A guard trace 12 and a guard trace 13 are inserted in the coupling area H1 and coupling area H2 separately. Moreover, two ends of the guard trace 12 are electrically connected to a grounding layer of the substrate 100 by a via 121 and via 122 while two ends of the guard trace 13 are electrically connected to the grounding layer of the substrate 100 by a via 131 and via 132.

Although the guard trace 12 and 13 can efficiently decrease the crosstalk noise of the serpentine delay line 11, the coupling area H1 and H2 must be large enough for the via 122 and 132 to be disposed inside the serpentine delay line 11, which is difficult to process. That is why, downsizing a structure for the serpentine delay line 11 is still a difficulty. Meanwhile, since the guard trace 12 and 13 with two ends connecting to the ground can merely be utilized in a structure of microstrip line, the utilization is still limited.

### SUMMARY OF THE INVENTION

A delay line structure is provided according to the present invention. The delay line structure does not need the installation of via inside the serpentine delay line and effectively reduces the crosstalk noise disturbance in the serpentine delay line.

A delay line structure is disposed on a substrate. The substrate includes a grounding layer and a layout layer, wherein the grounding layer includes a grounding circuit. The delay line structure accordingly includes a serpentine delay line, at least a first grounding guard trace and at least a second grounding guard trace.

The serpentine delay line is disposed in the layout layer in a manner of extending from an input end to an out put end in serpentine so as to form at least a first coupling area having a first opening toward a first direction and at least a second coupling area having a second opening toward a second direction opposite to the first direction.

The first grounding guard trace is disposed in the layout layer in a manner of extending from the first opening toward the first coupling area, having an interval between the first grounding guard trace and the serpentine delay line, wherein an end of the first grounding guard trace close to the first opening is electrically connected to the grounding circuit through a first via.

The second grounding guard trace is disposed in the layout layer in a manner of extending from the second opening toward the second coupling area, having an internal between the second grounding guard trace and the serpentine delay line, wherein an end of the second grounding guard trace close to the second opening is electrically connected to the grounding circuit through a second via.

According to an embodiment of the present invention, an end of the first grounding guard trace is electrically connected to the first via, and the end is positioned outside the first opening; an end of the second grounding guard trace is electrically connected to the second via, and the end is positioned outside the second opening.

According to an embodiment of the present invention, the serpentine delay line includes a strip line.

When compared with the delay line in prior art, which is not installed with grounding guard traces, the present invention avoids the crosstalk noise disturbance by means of the first grounding guard trace and the second grounding guard trace connecting to the ground with an end. When compared with the serpentine delay line having a guard trace with both ends connecting to the ground in prior art, since there is no need to install the via inside the serpentine delay line according to an embodiment of the present invention, the problem of being unable to downsize the serpentine delay line is easily solved.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a delay line structure in prior art;

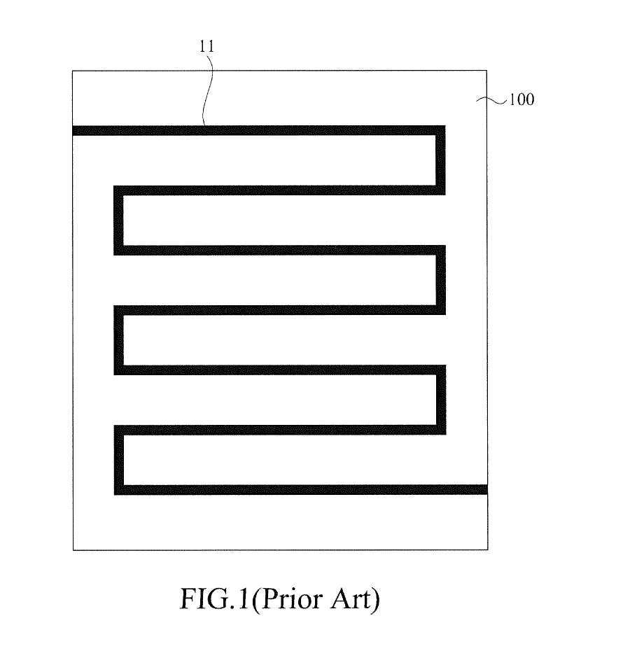

FIG. 2 is a schematic view showing a guard trace with both ends connecting to the ground being applied to a serpentine delay line in prior art;

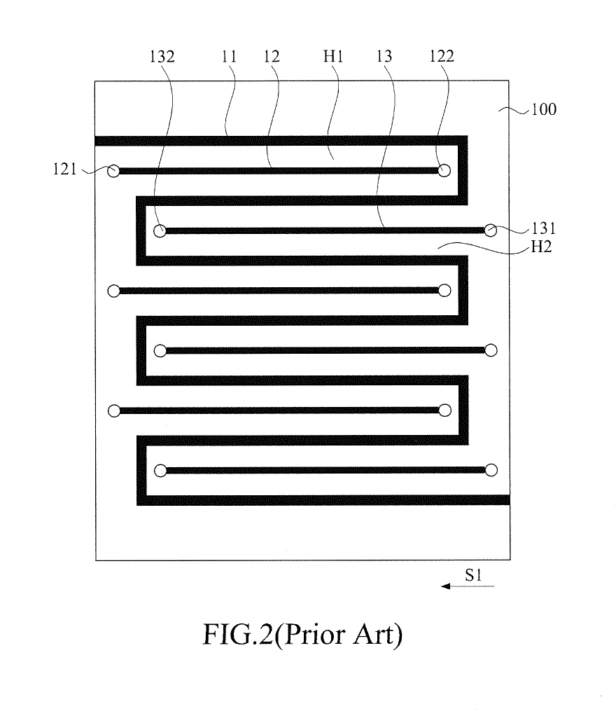

FIG. 3 is the upper view illustrating an embodiment of a serpentine delay line structure according to the present invention having grounding guard trace;

FIG. 4 shows a cross-sectional view of the strip line of the serpentine delay line according to an embodiment of the present invention taken along the A-A line in FIG. 3;

FIG. 5 is a measure figure showing the time domain transmit of various transmission lines employed in the serpentine delay line structure of the present invention;

FIG. 6 is an output eye diagram of a serpentine delay line without being installed with ground guard trace in prior art; and

FIG. 7 is an output eye diagram of a serpentine delay line of an embodiment of the present invention.

### DETAILED DESCRIPTION OF THE PREFERRED EMBODIMENT

The present invention relates to a delay line structure, and more particularly to a serpentine delay line structure with grounding guard traces. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

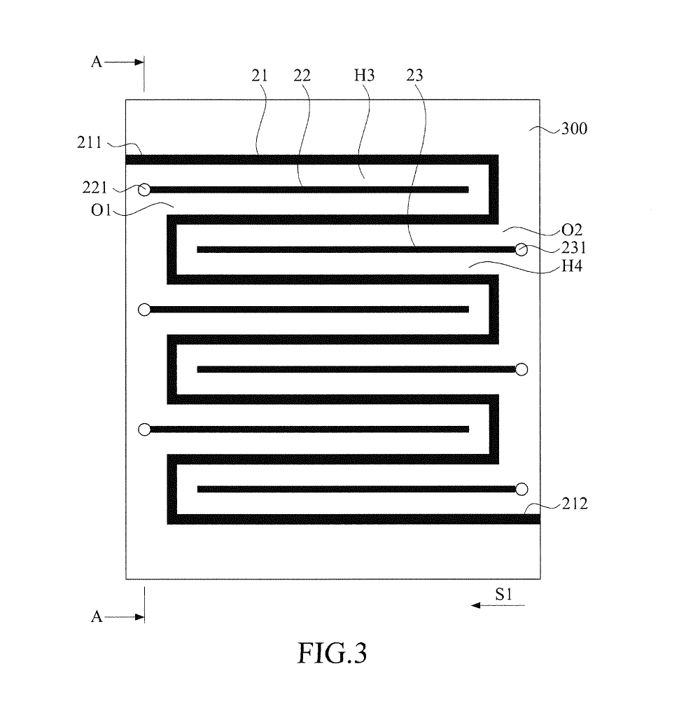

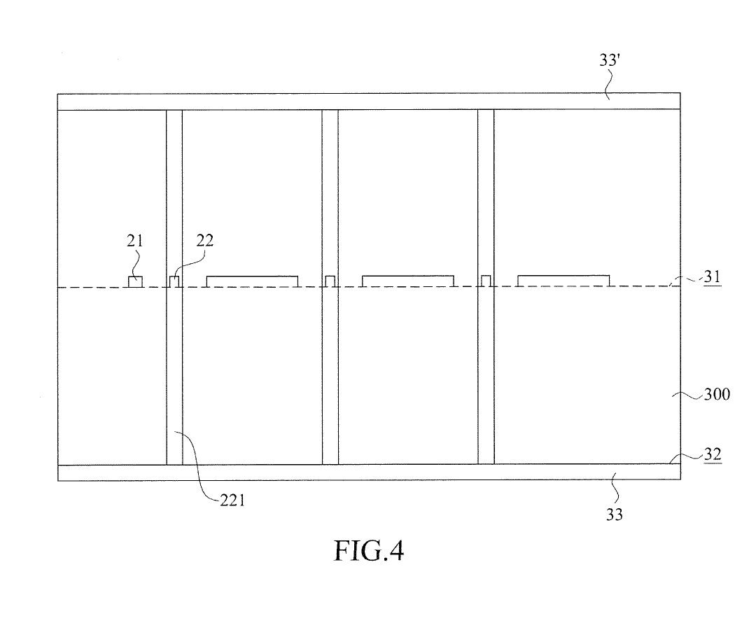

Referring to FIG. 3 and FIG. 4, wherein FIG. 3 is the upper view of an embodiment of a serpentine delay line structure having grounding guard trace according to of the present invention while; FIG. 4 shows the cross-sectional view of a strip line of the serpentine delay line according to the present invention taken along the A-A line in FIG. 3. A delay line structure is disposed on a substrate 300. The substrate 300 includes a grounding layer 32 and a layout layer 31, wherein the grounding layer 32 includes a grounding circuit 33. The delay line structure accordingly includes a serpentine delay line 21, at least a first grounding guard trace 22 and at least a second grounding guard trace 23.

The serpentine delay line 21 is disposed in the layout layer 31 in a manner of extending from an input end 211 to an out put end 212 in serpentine so as to form at least a first coupling area H3 having a first opening O1 toward a first direction S1 and at least a second coupling area H4 having a second opening O2 toward a direction opposite to the first direction S1, wherein the length and times of serpentine of the serpentine delay line 21 vary on the demand of signal delay time; the number of first coupling area H3 can be the same as or different from the number of the second coupling area H4.

The first grounding guard trace 22 is disposed in the layout layer 31 in a manner of extending from the first opening O1 toward the first coupling area H3, having an interval (not shown) between the first grounding guard trace 22 and the serpentine delay line 21, wherein an end (not shown) of the first grounding guard trace 22 close to the first opening O1 is electrically connected to the grounding circuit 33 through a first via 221, wherein according to an embodiment of the present invention, an end of the first grounding guard trace 22 is electrically connected to the first via 221, and the end is positioned outside the first opening O1.

The second grounding guard trace 23 is disposed in the layout layer 31 in a manner of extending from the second opening O2 toward the second coupling area H4, having an internal between the second grounding guard trace 23 and the serpentine delay line 21, wherein an end of the second grounding guard trace 23 close to the second opening O2 is electrically connected to the grounding circuit 33 through a second via 231, wherein according to an embodiment of the present invention, an end of the second grounding guard trace 23 is electrically connected to the second via 231, and the end is positioned outside the second opening O2.

Moreover, the delay line structure of the present invention is applied to various kinds of substrate 300. For example, the substrate 300 may include materials having a plurality of dielectric constants and the substrate 300 may include materials having a single dielectric constant. The layout layer 31 is disposed inside the substrate 300. According to an embodiment of the present invention, the serpentine delay line 32 includes a strip line as it is shown in FIG. 4, and the upper side and lower side of the substrate 300 respectfully includes grounding circuit 33 and 33′. When at least one of the grounding circuit 33 and 33′ is electrically connected by the via 221, the effect of ground guard is reached.

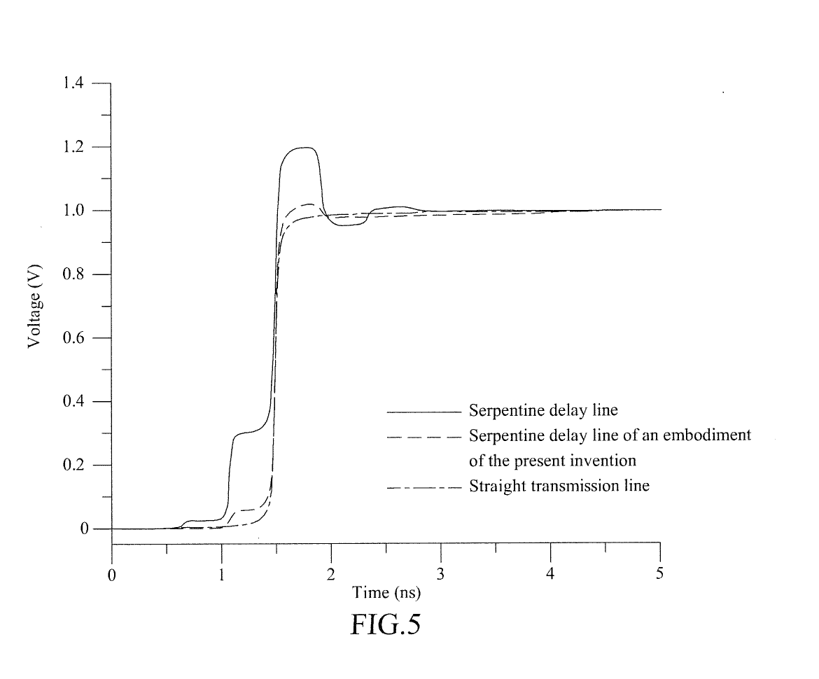

Referring to FIG. 5, FIG. 5 is a measure figure showing the time domain transmit of various transmission lines. It is obvious that the waveform measured by a straight transmission line is an ideal square wave signal. On the contrary, the waveform measured by a serpentine delay line without being installed with ground guard trace shows ups and downs, which is very different from the square wave signal. The waveform measured by the serpentine delay line of an embodiment of the present invention is very close to the ideal square wave signal. In other words, the delay line structure of the present invention can effectively reduce the disturbance of crosstalk noise.

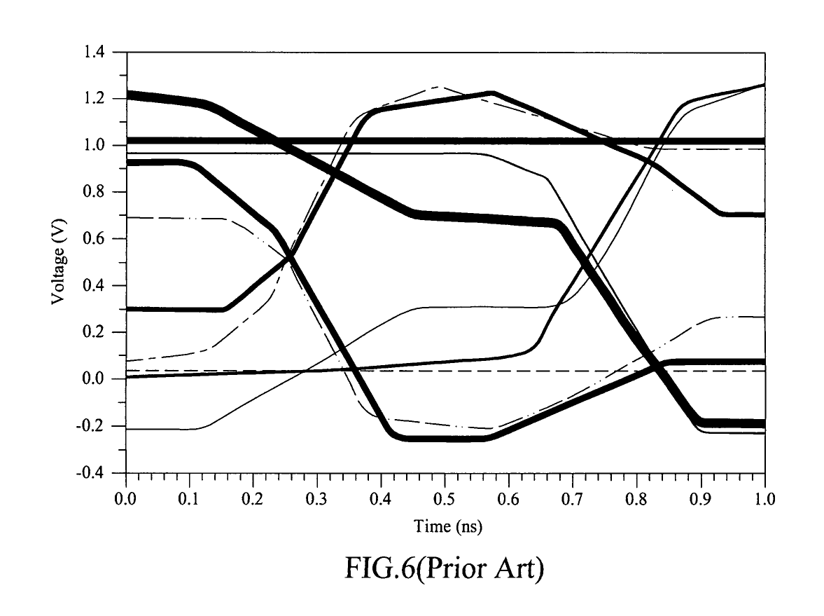

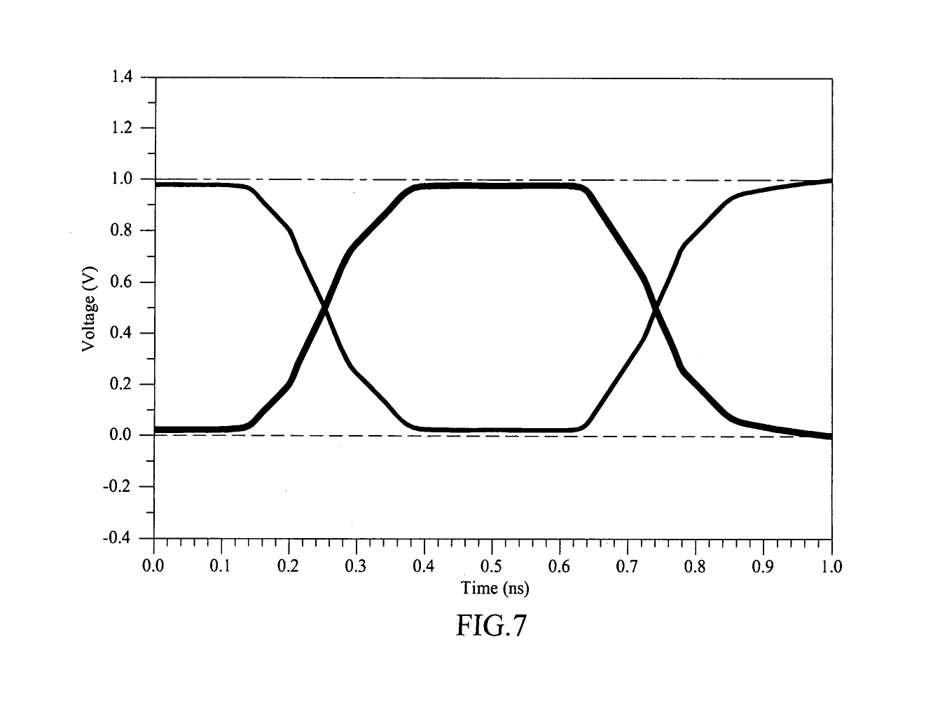

Referring to FIG. 6 and FIG. 7, wherein FIG. 6 is an output eye diagram of a serpentine delay line without being installed with ground guard trace in prior art while FIG. 7 is an output eye diagram of a serpentine delay line of an embodiment of the present invention. The abovementioned two eye diagrams are measured with an electronic measurement and simulation software, Advanced Design System (ADS) 2006, of the company of Agilent Technologies, Taipei, Taiwan. It is clear that the output eye diagram of a serpentine delay line of an embodiment of the present invention has better signal integrity than the output eye diagram of a serpentine delay line without being installed with ground guard trace in prior art.

In conclusion, when compared with the delay line in prior art, which is not installed with grounding guard traces, the present invention avoids the crosstalk noise disturbance by means of the first grounding guard trace and the second grounding guard trace connecting to the ground with an end. When compared with the serpentine delay line having a guard trace with both ends connecting to the ground in prior art, since there is no need to install the via inside the serpentine delay line of the present invention, the problem of being unable to downsize the serpentine delay line is easily solved. Meanwhile, since a strip line structure can also applied in an embodiment of the present invention, it is more flexible for manufacturing.

While the present invention has been particularly shown and described with reference to a preferred embodiment, it will be understood by those skilled in the art that various changes in form and detail may be without departing from the spirit and scope of the present invention.

What is claimed is:

1. A delay line structure disposed on a substrate, the substrate including a grounding layer and a layout layer, the grounding layer including a grounding circuit, the delay line structure comprising:
a serpentine delay line disposed in the layout layer in a manner of extending from an input end to an out put end in serpentine so as to form at least a first coupling area having a first opening toward a first direction and at least a second coupling area having a second opening toward a second direction opposite to the first direction;
at least a first grounding guard trace disposed in the layout layer in a manner of extending from the first opening toward the first coupling area, having an interval between the first grounding guard trace and the serpentine delay line, wherein an end of the first grounding guard trace close to the first opening is electrically connected to the grounding circuit through a first via; and
at least a second grounding guard trace disposed in the layout layer in a manner of extending from the second opening toward the second coupling area, having an internal between the second grounding guard trace and the serpentine delay line, wherein an end of the second grounding guard trace close to the second opening is electrically connected to the grounding circuit through a second via.

2. The delay line structure according to claim 1, wherein a number of the first coupling area is the same as a number of the second coupling area.

3. The delay line structure according to claim 1, wherein the layout layer is disposed inside the substrate.

4. The delay line structure according to claim 1, wherein the serpentine delay line includes a strip line.

5. The delay line structure according to claim 1, wherein the substrate is made from materials having a plurality of dielectric constants.

6. The delay line structure according to claim 1, wherein an end of the first grounding guard trace is electrically connected to the first via, and the end is positioned outside the first opening.

7. The delay line structure according to claim 1, wherein an end of the second grounding guard trace is electrically connected to the second via, and the end is positioned outside the second opening.
